(19) United States
(12) Patent Application Publication
(10) Pub. No.: US 2011/0006450 A1
(43) Pub. Date: Jan. 13, 2011

(54) DENTAL SINTERING FURNACE AND METHOD FOR SINTERING CERAMIC DENTAL ELEMENTS

(75) Inventors: Marc Stephan, Loerrach (DE); Marcel Mallah, Peine (DE)

Correspondence Address: Clements Bernard PLLC, 1901 Roxborough Road, Suite 250, Charlotte, NC, 28211, US

(73) Assignee: VITA ZAHNFABRIK H. RAUTER GMBH & CO. KG, Bad Saeckingen (DE)

(21) Appl. No.: 12/921,953

(22) PCT Filed: Feb. 13, 2009
(86) PCT No.: PCT/EP2009/051719

§ 371 Date: Sep. 13, 2010

(30) Foreign Application Priority Data
Mar. 11, 2008 (EP) 08102475.4

(51) Int. Cl. A61C 13/20; H05B 6/70

(52) U.S. Cl. 264/16; 219/690

(57) ABSTRACT

A dental sintering furnace for sintering ceramic dental elements comprises a receiving chamber (10) for receiving the dental element (14) to be sintered. The receiving chamber (10) is surrounded by an electric heating unit (24) for heating the dental elements (14) to a pre-sintering temperature. Further, the receiving chamber (10) is surrounded by an annular microwave conductor (30) designed as a hollow conductor. On an inner wall (46), the microwave conductor comprises a plurality of decoupling slots (48) to decouple the microwaves in the direction of the receiving chamber (10). In a method for sintering ceramic dental elements, all the dental elements are first heated to a pre-sintering temperature by means of the electrical heating unit (24) and then the dental elements (14) heated to the pre-sintering temperature are irradiated by microwave radiation for coupled heating of the dental elements (14) to the sintering temperature.

The invention relates to a dental sintering furnace and a method for sintering ceramic dental elements, particularly by use of said dental sintering furnace.

Dental elements, such as crown and bridge frameworks and the like, are often produced from ceramic. The materials used are particularly dental ceramic materials such as zirconium dioxide, aluminum oxide, combinations of aluminum oxide and zirconium dioxide, as well as glass-infiltrated aluminum and zirconium dioxides.

For manufacturing dental elements from zirconium dioxide, it is known to sinter these elements. This is performed by subjecting the dental element to high temperatures of about 1500° C. through a long process time which often will amount to 5-10 hours. For avoiding damage to the dental elements and precluding non-uniform shrinkage, the dental elements have to be heated in the most uniform manner possible. For this purpose, it is known to arrange dental elements in a sintering furnace comprising a conventional heating unit which normally is an electric heating unit. Heating the dental elements accommodated in a receiving chamber is thus performed in a conventional manner by heat radiation and/or convection.

It is further known, e.g. from EP 07 13 633, to perform the heating of ceramic components, in addition to using a conventional heating unit, by use of microwaves. Herein, the heating of the receiving chamber is effected simultaneously by a conventional heating unit in the form of an electric heating unit and by a microwave device. The heating elements serving for the heating process are arranged within the receiving chamber. Further, microwaves will be coupled into the receiving chamber. Since, within the receiving chamber, the microwaves will propagate inhomogeneously, the presently described arrangement makes it necessary to provide a microwave stirrer. In spite of the provision of such a microwave stirrer, the microwave field within the receiving chamber will still not be homogeneous. This leads to an inhomogeneous heating of the ceramic components. Especially, there is a risk that components may become partially overheated. As a result, components may be damaged or even destroyed. Since the quality requirements to ceramic dental elements, particularly with regard to their dimensions and the uniformity of the nature of their material throughout the cross sections, are extremely high, the apparatus described in EP 07 13 633 is not suited for the production of high-quality ceramic dental elements. A further disadvantage of the apparatus described in EP 07 13 633 resides in that said heating elements arranged within the receiving chamber will massively impair the homogeneity of the microwaves.

It is an object of the invention to provide a dental sintering furnace which is adapted to produce ceramic dental elements of high quality. Further, it is an object of the invention to provide a corresponding method for the sintering of ceramic dental elements.

The above object is achieved by a dental sintering furnace according to claim 1 and, respectively, a method for sintering ceramic dental elements according to claim 8.

The dental sintering furnace of the invention, provided for the sintering of ceramic dental elements such as crown and bridge frameworks and the like, comprises a preferably cylindrical, particularly circular-cylindrical receiving chamber for receiving the dental elements to be sintered. The ceramic dental elements preferably comprise zirconium dioxide and, according to a particularly preferred embodiment, are fully made of zirconium dioxide. Further, a heating unit, particularly a conventional heating unit, is provided for heating the dental elements arranged in the receiving chamber. With the aid of said heating unit, particularly through of heat radiation but optionally also through convection, the dental elements will be heated to a pre-sintering temperature. This temperature will preferably be in the range of about 800-1100° C. Preferably, the heating unit is arranged within the receiving chamber and preferably surrounds the receiving chamber at least partially. Optionally, individual heating elements, such as heating spirals, can be arranged at regular distances around the receiving chamber. In addition to a heating unit, particularly of a conventional type, a microwave generator is provided. The microwave generator is connected to a microwave conductor surrounding the receiving chamber at least partially, and preferably completely. Said microwave conductor, into which the microwaves generated by the microwave generator are introduced, comprises a plurality of decoupling elements. The decoupling elements are operative to decouple microwaves in the direction of the receiving chamber. Preferably, the decoupling elements are designed to act corresponding to individual microwave sources and microwave antennae, respectively. Said individual decoupling elements are preferably arranged around the receiving chamber in a manner allowing a highly homogeneous microwave field to be generated within the receiving chamber.

Due to said extremely homogeneous microwave field, it is rendered possible to sinter a plurality of dental elements within the receiving chamber at the same time. Further, the combination of a—particularly conventional—heating unit with a microwave generator which, because of the provision of a plurality of decoupling elements, will generate an extremely homogeneous microwave field within the receiving chamber, makes it possible to reduce the sintering time significantly. In particular, by use of the dental sintering furnace of the invention, the sintering time can be reduced by more than 50%, particularly by more than 70%.

The decoupling elements connected to the microwave conductor or formed thereby are preferably arranged in a uniform manner around the receiving chamber. In case of an e.g. circular-cylindrical receiving chamber, the decoupling elements are arranged at constant distances along the circumference. This makes it possible, for instance, to arrange the decoupling elements at a circumferential offset relative to individual heating elements, such as e.g. heating rods or heating spirals, of the heating unit, and thus to reduce the disturbing effects exerted on the microwaves by the heating unit. Herein, the microwave conductor preferably has an annular shape, more preferably a circular annular shape, and fully surrounds the receiving chamber. The microwave conductor is preferably formed as a hollow conductor so that the microwaves can propagate within the hollow conductor, the material of the hollow conductor being selected to the effect of avoiding an escape of microwaves through the walls of the hollow conductor. Preferably, the hollow conductor has a rectangular cross section.

In order to generate, within the receiving chamber, a microwave field of the highest possible homogeneity, the decoupling elements are arranged at an inner wall of the microwave conductor facing in the direction of the receiving chamber. According to a particularly preferred embodiment, the decoupling elements comprise decoupling slots provided on the inner wall of the microwave conductor. In a hollow conductor of a circular annular shape, the plurality of slots are with particular preference distributed in a uniform manner along the circumference. Further, for obtaining a magnetic field with the highest possible homogeneity, it is advantageous if the slots are arranged at an inclination relative to the circumferential direction of the microwave conductor. The inclination of the slots relative to the circumferential direction is preferably in the range of 10°-15°. The angle of inclination a is preferably calculated according to the equation

$${sin}^{2} α = \frac{1 , 22}{2 n + 1} ,$$

with n denoting the number of slots. Preferably, the decoupling slots are arranged alternately with ascending and descending inclination.

According to a further preferred embodiment of the invention, at least a part of the decoupling elements are provided with an adjustment means for adjusting the intensity and/or the propagation direction of the microwaves at the corresponding decoupling element. Said adjustment means makes it possible to change the slot width, the slot length and/or the angle of inclination. With particular preference, the adjustment means comprises a rod-shaped element. By a preferably metallic rod-shaped element, the propagation direction and/or the intensity of the microwaves can be influenced. Said rod preferably is arranged vertically to the decoupling slot and more preferably is oriented in the direction of the receiving chamber. Thus, in case of a circular-cylindrical receiving chamber, the rod is arranged in radial direction. With particular preference, the position of said preferably rod-shaped adjustment means can be changed. Preferably, for changing the distance, said preferably rod-shaped element is arranged to be displaced and/or pivoted relative to the decoupling slot. In this regard, it is particularly preferred that said rod be displaceably held on an outer wall opposite the inner wall of the microwave conductor.

The invention further relates to a method for sintering ceramic dental elements which preferably is performed by use of the above described dental sintering furnace. According to the invention, the dental elements arranged in the receiving chamber will be heated to a pre-sintering temperature by a heating unit, particularly of a conventional type, such as e.g. an electric heating unit. The temperature is normally in the range of 800-1100° C. According to the invention, the dental elements which have been heated to the pre-sintering temperature will be irradiated by microwave radiation for thus heating the dental elements to the sintering temperature. Herein, the irradiation of the dental elements is performed by use of a microwave field with the highest possible homogeneity, said microwave field being preferably generated by the above described dental sintering furnace.

In the method according to the invention, there is preferably provided a temperature-controlled power feedback control of the conventional heating unit. A temperature-controlled microwave radiation is not required. It is particularly preferred that the control of a microwave generator for generating the microwave radiation is carried out exclusively by using one or a plurality of time profiles. Thus, while sintering the dental elements, a complex temperature measurement at the dental elements will not be required. According to the invention, it is instead sufficient to define and store the time profile for achieving the pre-sintering temperature. Thus, it is provided according to the invention that, upon reaching the sintering temperature, i.e. preferably after lapse of a corresponding time profile, the dental elements will be irradiated by microwaves. Preferably, according to the invention, time periods of 5-60 minutes will be sufficient.

For control of the preferably conventional heating unit, it is provided according to a preferred embodiment that a thermal element or temperature sensor is arranged in the receiving chamber or furnace chamber. During the sintering process, the temperature achieved by the heating unit is preferably kept constant throughout the dwelling time. Herein, the target temperature to be achieved by the preferably conventional heating unit may in fact also be distinctly above a pre-sintering temperature of 800-1100° C.

To allow for controlled sintering of the dental elements, it is particularly preferred that the microwave radiation will be switched on only when the pre-sintering temperature of preferably 800-1100° C. has been reached. The microwave radiation will thus be incident only onto suitably preheated dental elements. Accomplished thereby is an extremely homogeneous structure of the material under treatment.

A preferred embodiment of the invention will be explained in greater detail hereunder with reference to the accompanying drawings.

In the drawings, the following is shown:

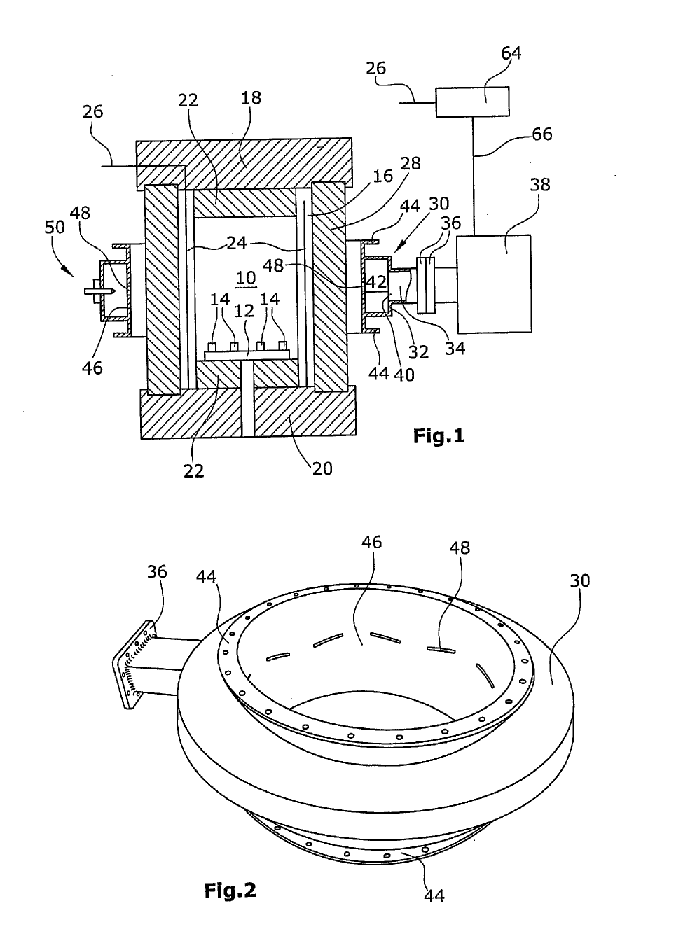

FIG. 1 is a schematic sectional view of a dental sintering furnace,

FIG. 2 is a schematic perspective view of a microwave conductor,

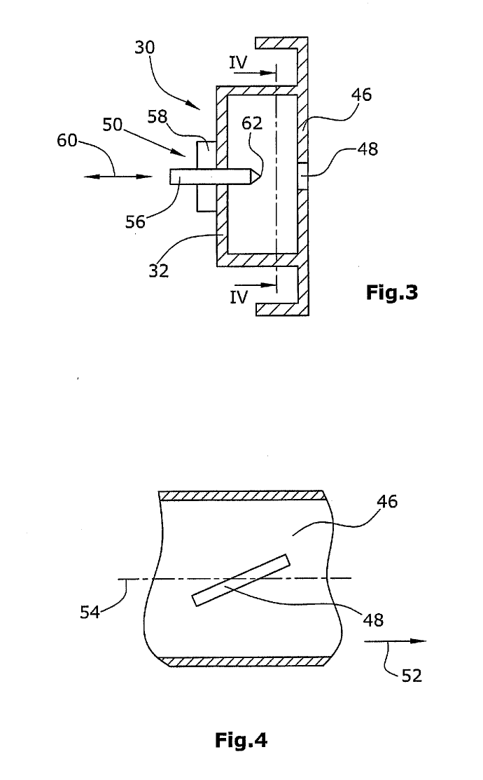

FIG. 3 is a schematic sectional view of the microwave conductor transversely to the circumferential direction, and

FIG. 4 is a schematic sectional view in the direction of line IV-IV in FIG. 3.

The dental sintering furnace comprises a receiving chamber 10 accommodating, on a support element 12 arranged e.g. internally of said receiving chamber, a plurality of dental elements 14 which are to be sintered. In the illustrated embodiment, the receiving chamber 10 is defined by a cylindrical housing 16 which can be closed by a cover 18 and by a bottom 20. On those sides of both cover 18 and bottom 20 that are facing toward the receiving chamber 10, respective insulating elements 22 are provided for preventing an escape of microwaves out of receiving chamber 10.

Arranged internally of housing 16 is a heating unit 24 optionally comprising a plurality of heating elements distributed along the circumference of the receiving chamber. Said heating unit 24 is preferably an electric heater which is connected to a control unit via a line 26. Further, said housing 16 is surrounded by a high-temperature insulation 28 so that the heat generated by heating unit 24 will not be radiated to the outside.

According to the invention, housing 16 and thus also receiving chamber 10 are surrounded by an annular microwave conductor 30. Microwave conductor 30 is formed as a hollow conductor and has a rectangular cross section. On an outer wall 32 of microwave conductor 30, preferably extending parallel to the cylindrical housing 16, a feed line 34 is provided. Feed line 34 can e.g. also have a rectangular cross section, and it also has a hollow shape. A microwave generator 38 is connected to feed line 34 with the aid of flanges 36. The microwaves generated by microwave generator 38 will be fed into an inner chamber 42 of said hollow microwave conductor 30 via the feed line 34 and an opening 40 provided in the outer wall 32 of microwave conductor 30.

For attachment to a holding support, not shown, two annular flanges 44 are provided on microwave conductor 30.

With the aid of said flanges 44, it is further possible to arrange two or more preferably annular microwave conductors 30 above each in a stacked configuration. In such an arrangement, each microwave conductor 30 is preferably connected to a microwave generator 38 of its own.

According to the invention, decoupling slots 48 are provided which particularly are arranged on the circumference of an inner wall 46 of microwave conductor 30. In the illustrated embodiment, said decoupling slots 48 are provided as parts of a decoupling element which additionally comprises an adjustment means 50. The decoupling slots 48 are arranged in a uniform configuration in the circumferential direction 52 (FIG. 4) in said inner wall 46. Preferably, all decoupling slots 48 have the same length and the same width. Relative to a longitudinal axis 54 extending in the circumferential direction 52, the slots 48 are preferably inclined, with the inclinations extending in alternating directions (FIG. 2). The inclination angles, however, are preferably identical for all slots.

For setting the intensity and/or the propagation direction of the microwaves emitted in the direction of receiving chamber 10 through said slots 48 acting as microwave sources, said adjustment means 50 is provided. In the illustrated embodiment, the adjustment means comprises a rod-shaped adjustment element 56 fixed to outer wall 32 by a fastening means 58. Said rod 56 is displaceable in the direction of arrow 60, thus allowing the distance between a rod tip 62 and slot 48 to be varied for adjustment of the intensity and/or the propagation direction. Optionally, rod 56 can also be pivotable.

For performing the method of the invention, a control unit 64 is provided which is connected to heating unit 24 via said electric line 26, and to microwave generator 38 via a line 66. Via said lines 26,66, control commands can be transmitted to heating unit 24 and microwave generator 38, respectively. Heating unit 24 is controlled by time/temperature control. For this purpose, a thermal element, not shown, is arranged within receiving chamber 10 for measuring the temperature prevailing within chamber 10. Particularly, the time profiles will be monitored by said control unit 64. The time profiles serve, on the one hand, for achieving the pre-sintering temperature in receiving chamber 10 and thus for timing control of the heating unit 24 and, on the other hand, for timing control of the microwave generator.

1-11. (canceled)

12. A dental sintering furnace for sintering ceramic dental elements, comprising
a receiving chamber for receiving the dental elements to be sintered,
a heating unit for heating the dental elements arranged in said receiving chamber to a pre-sintering temperature, and
a microwave conductor connected to a microwave generator and at least partially surrounding the receiving chamber, said microwave conductor comprising a plurality of decoupling elements for decoupling microwaves in the direction of the receiving chamber.

13. The dental sintering furnace according to claim 12, wherein said microwave conductor is designed as a particularly annular hollow conductor.

14. The dental sintering furnace according to claim 12, wherein said microwave conductor is connected to a sole microwave generator, particularly via a feed conductor.

15. The dental sintering furnace according to claim 12, wherein said decoupling elements are arranged on an inner wall of the microwave conductor facing in the direction of the receiving chamber, and preferably comprise decoupling slots.

16. The dental sintering furnace according to claim 12, wherein at least a part of said decoupling elements are provided with an adjustment means for setting the intensity and/or the propagation direction of the microwaves.

17. The dental sintering furnace according to claim 16, wherein said adjustment means comprises a rod extending particularly vertically to the decoupling slot and preferably facing in the direction of the receiving chamber.

18. The dental sintering furnace according to claim 16, wherein said rod, for changing its distance to the decoupling slot, is held in a displaceable manner, particularly in an outer wall opposite to the inner wall of the microwave conductor.

19. A method for sintering ceramic dental elements, particularly by use of a dental sintering furnace according to claim 12, said method comprising the following steps:
heating said dental elements to a pre-sintering temperature by a heating unit, and
irradiating said dental elements heated to the pre-sintering temperature with microwave radiation so as to heat the dental elements to the sintering temperature.

20. The method according to claim 19, wherein, after the pre-sintering temperature has been reached, said heating unit is operated until the sintering temperature has been reached.

21. The method according to claim 19, wherein the microwave radiation is switched on only when the pre-sintering temperature has been reached.

22. The method according to claim 19, wherein the control of a microwave generator is performed exclusively by means of a time profile.
